(19) United States
(12) Patent Application Publication
(10) Pub. No.: US 2013/0241895 A1
(43) Pub. Date: Sep. 19, 2013

(54) INPUT DEVICE

(71) Applicant: GM GLOBAL TECHNOLOGY OPERATIONS LLC, Detroit, MI (US)

(72) Inventors: David VOSS, Ruesselsheim (DE); Joerg HEDRICH, Mainz (DE); Marc FUERST, Eisenberg (DE); Stefan POPPE, Darmstadt (DE); Andreas LANG, Werlgesheim (DE); Michael WAGNER, Rimbach (DE); Marius WRZESNIEWSKI, Darmstadt (DE)

(73) Assignee: GM Global Technology Operations LLC, Detroit, MI (US)

(21) Appl. No.: 13/779,229

(22) Filed: Feb. 27, 2013

(30) Foreign Application Priority Data
Mar. 13, 2012 (DE) 10 2012 005 084.4

(51) Int. Cl. G06F 3/041

(52) U.S. Cl. CPC G06F 3/0418
USPC 345/178

(57) ABSTRACT

An input device includes a sensor surface that is sensitive to a touch by a foreign body and a control unit. The control unit is configured to determine a first sensitive region of the sensor surface and, when the first sensitive region is touched by the foreign body, to supply a predetermined first detection signal. The control unit comprises means for estimating a direction of an acceleration change acting parallel to the sensor surface and is configured, under an effect of the acceleration change, to shift the first sensitive region at times in an active direction of the acceleration change.

### CROSS-REFERENCE TO RELATED APPLICATION

This application claims priority to German Patent Application No. 10 2012 005 084.4, filed Mar. 13, 2012, which is incorporated herein by reference in its entirety.

### TECHNICAL FIELD

The technical field relates to an input device, in particular for controlling an electronic device in a motor vehicle.

### BACKGROUND

So-called touch screens are becoming increasingly popular as input devices for electronic devices such as, for example, mobile telephones, small computers, radio devices etc., as they make possible a comfortable and clear control of numerous functions, without a large number of switches, controllers or other input means having to be expensively installed. Position, appearance and function of an operating field on a touch screen are definable through software, so that a uniform model of touch screens that can be cost-effectively produced can be employed in a wide range of devices.

These advantages give rise to the need of being able to control electronic devices installed in motor vehicles by means of touch screen. However, this creates the problem that no key stroke can be realised with a touch screen and the mere touching on its surface is sufficient in order to bring about a reaction. Since the occupants of a travelling vehicle are subject to continually changing accelerations, be it due to road irregularities or when travelling through curves, it can be difficult for a user to safely hit an operating field defined on a touch screen with the finger. If the finger fails to hit the desired operating field because of an unforeseen acceleration, this can trigger an undesirable action of the device control through the operating field. This can render the operation of devices, which require a sequence of a plurality of precisely placed touch actions for their control, such as for example mobile telephones or navigation devices, extremely difficult.

In order to remedy this problem, an input device was proposed in US 2011/0082620 A1, with which the size of a sensitive region of the touch screen, which has to be touched for triggering a desired action, a so-called “soft button”, is variable as a function of the intensity of the accelerations to which the touch screen is subjected. However, in order to be able to enlarge the sensitive regions upon intense acceleration, these have to keep a sufficient distance from one another. For this reason, the number of the sensitive regions that can be defined on a given surface of the touch screen is small and a small number of sensitive regions require a large number of actuations for inputting a complex command, which in turn increases the probability that an error occurs when inputting the command.

If through a sudden change of the external acceleration the finger of the user is deflected so far that at times it leaves the desired sensitive region or even happens to get to an adjacent sensitive region, an operating error is the result. Since this region must never become so large that it overlaps with an adjacent sensitive region, the safety with which this conventional input device can be operated is limited by the distance of the sensitive regions from one another.

At least one object herein is to provide an input device that can still be safely operated under the influence of external accelerations even if a sensitive area is small or a plurality of sensitive regions are arranged closely adjacent to one another. In addition, other objects, desirable features and characteristics will become apparent from the subsequent summary and detailed description, and the appended claims, taken in conjunction with the accompanying drawings and this background.

### SUMMARY

In an exemplary embodiment, an input device having a sensor surface that is sensitive to touch by a foreign body and a control unit is provided. The control unit is equipped to determine at least one first sensitive region of the sensor surface and when this first sensitive region is touched by the foreign body, to supply a predetermined first detection signal. The control unit furthermore comprises means for estimating at least the direction of an acceleration change acting parallel to the sensor surface and is equipped when subjected to the effect of an acceleration change to shift at times the first sensitive region in operational direction of this acceleration change. Thus, the sensitive region on the sensor surface follows an involuntary movement of the finger of a user induced through centrifugal force or vibration of the vehicle so that the finger, although it moves relative to the sensor surface, does not leave the determined sensitive region in the process.

Practically, the extent of the shifting of the sensitive region is greater, the greater the amount of the active acceleration change.

In an exemplary embodiment, in order to offset any deviations between a movement of the finger of the user and the compensating movement of the first sensitive region, the dimensions of the sensitive region in particular in active direction of the acceleration change are greater, the greater the acceleration change.

In an embodiment, perpendicularly to the active direction of the acceleration change, the dimension of the first sensitive region can be independent of the amount of the acceleration change since in this direction no involuntary movement of the finger is to be expected.

The sensor surface of the input device according to an embodiment is provided with an invariable, for example, printed-on symbol that indicates the position of the sensitive region. For example, the sensor surface is simultaneously designed as a dynamically activatable display surface on which a symbol representing the position of the part region can be represented.

Such a symbol could follow the shifting of the assigned sensitive region on being acted upon by an acceleration change. However, this would make it rather difficult for a user to hit the sensitive region with the finger, which is why the position of the symbol is practically independent of the active acceleration.

With most practical applications, two or more sensitive regions will be determined on the sensor surface. Since the shift of the sensitive regions according to an embodiment is only at times, the distance of the sensitive region from one another does not constitute an upper limit for the permissible shift; instead, with adequately strong acceleration change, the first sensitive region can be shifted by all means so far that it overlaps with the second sensitive region in the un-accelerated state. In order to estimate the acceleration acting in vehicle transverse direction, the means for estimating the acceleration can comprise a speedometer and a steering angle sensor, which are already present in many motor vehicles for other purposes.

In an embodiment, an acceleration sensor, in particular for estimating a vertical acceleration component, is connected to the sensor surface in a unit in order to detect as accurately as possible the acceleration to which a finger actuating the sensor surface is also subjected.

According to a further embodiment, the control unit is of the self-learning type; it can be equipped, in particular, to measure a movement of the foreign body on the sensor surface resulting from an active acceleration change in order to learn the relationship between acceleration change and deflection of the finger in this way, and in knowing this relationship, to displace the first sensitive region in each case such as under the influence of the respective current acceleration change the finger of the user will probably move.

### BRIEF DESCRIPTION OF THE DRAWINGS

The various embodiments will hereinafter be described in conjunction with the following drawing figures, wherein like numerals denote like elements, and wherein:

FIG. 1 is a block diagram of an input device according to an exemplary embodiment;

FIG. 2 is a screen detail of the input device of FIG. 1 in the unaccelerated state or a state subjected to a constant acceleration;

FIG. 3 is the screen detail of the input device of FIG. 1 in the case when a slightly increasing acceleration to the left is active;

FIG. 4 is the screen detail of the input device of FIG. 1 in the case of a greatly increasing acceleration to the left;

FIG. 5 is the screen detail of the input device of FIG. 1 in the case of an increasing acceleration towards the top;

FIG. 6 is a flow diagram of a working method of the control unit of the input device in accordance with an exemplary embodiment;

FIG. 7 is the screen of the input device of FIG. 1 during the handwritten input of a sign; and

FIG. 8 is the screen of the input device of FIG. 1 with the handwritten input under the influence of a sudden acceleration.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

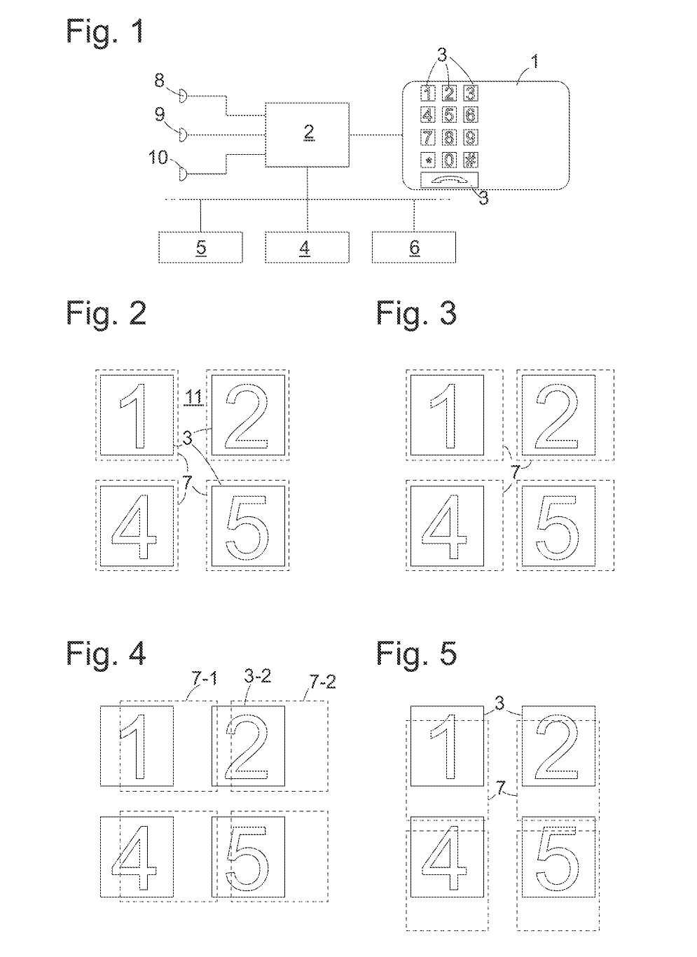

FIG. 1 shows a block diagram of an input device according to an exemplary embodiment which for example is installed in the instrument panel of a motor vehicle. The input device comprises a touch screen with a display screen 1, e.g. an LCD matrix display. The brightness and/or the colour tone of the pixels of the display screen 1 is individually controllable through a control unit 2 in order to be able to reflect any images on the display screen 1 whose graphic elements, which for example represent keys or controls of a device to be controlled through the input device, in each case comprise a multiplicity of these pixels. In the representation of FIG. 1, the pixels are activated in order to replicate a key pad of a mobile phone. Although the mode of operation of the input device is also explained in the following by means of this example, it is to be understood that the control unit 2 can be equipped to represent any other images on the display screen 1 and thus for a user interface for any other devices carried along in the motor vehicle such as for example a navigation system, a radio, media playback devices or the like.

The display screen 1 comprises a touch-sensitive surface. The construction and the functionality of such a sensor surface are known to the person skilled in the art so that these need not be explained in detail here. To understand the input device contemplated herein, the control unit 2 is equipped to detect by means of signals fed back from the sensor surface of the display screen 1 if or at which point the finger of a user touches the display screen 1.

Conventionally, a touch screen is operated in that the control unit 2 reproduces images 3 of keys and at the same time utilises the detected signal from the sensor surface as to whether a touch at the location of the image 3 is being registered. If yes, the control unit 2 supplies a corresponding detection signal to the respective device controlled by it such as for example the mobile phone 4. In that the user one after the other touches images 3 of number keys, he can select a phone number and subsequently by touching the image 3 of a calling key at the foot of the number field, prompt the mobile phone 4 to establish a call connection to the selected number.

In addition to the mobile phone 4, other devices 5, 6 such as a navigation device or a radio can be connected to the control unit for the operation of which the control unit 2 reproduces other images on the display screen 1.

If the vehicle is in motion, it is not advisable for the driver, even for safety reasons, to attempt entering a telephone number and establishing a call connection, but it is also difficult for a co-driver to touch the represented number keys without error when the vehicle is subjected to continuously changing accelerations through road irregularities and curves. Although inputting the phone number can be slightly simplified in that, as shown in FIG. 2, the limits of the sensitive regions 7 of the display screen 1 (shown as interrupted line here, but not visible on the display screen 1), touching of which is interpreted by the control unit 2 as actuation of the respective keys represented in these regions, are slightly larger than the images 3 of the keys displayed in these sensitive regions 7, but these measures alone cannot prevent that an abrupt acceleration cannot be offset by the user and his finger hits the display screen 1 in a functionless zone next to the actually intended sensitive touch region 7, or even hits it in an adjacent sensitive region 7 assigned to another key.

In an embodiment, in order to solve this problem, the control unit 2 is connected to means 8, 9, 10 for estimating an acceleration vector acting on the display screen 1. These means can comprise an acceleration sensor that is sensitive in a plurality of directions in space, which is able to directly supply a signal that is representative for the currently active acceleration vector. In the case under consideration here, the control unit 2 is connected to a speedometer 8 and a steering angle sensor 9, in order to calculate by means of the measured steering angle the curvature radius of the path travelled by the vehicle and from this and the speed of the motor vehicle, the acceleration “ay” acting in vehicle transverse direction y. The display screen 1 is installed in the instrument panel so that the vehicle transverse direction runs parallel to its sensor surface. A second space direction that is orthogonal to the vehicle transverse direction and parallel to the sensor surface is designated z-direction in the following for the sake of simplicity, even if this direction is not necessarily exactly vertical. In an embodiment, for detecting the acceleration component in this z-direction, an acceleration sensor 10 is connected to the display screen 1 in a unit. In that acceleration sensor 10 and display screen 1 are preassembled in a unit and are jointly assembled, it is ensured that the direction in which the acceleration sensor 10 is sensitive, is oriented parallel to the sensor surface and that the acceleration, which can be different at different locations of the vehicle, is measured at a point at which it corresponds with sound accuracy to the acceleration acting on the hand of the user.

When the vehicle enters a left-hand curve and because of this is subjected to an increasing acceleration to the left, it is to be expected that the finger of a user that approaches the display screen is deflected to the right against the acceleration acting on the vehicle and consequently, for example instead of the image 3 of the FIG. “1” touches the display screen 1 in a region 11 (see FIG. 2) between the images of the keys “1” and “2”. This is taken into account by the control unit 2 according to an embodiment in that when it registers a moderately increasing acceleration to the left it expands the sensitive regions 7 assigned to the keys in each case to the right as shown in FIG. 3.

In this way, a touch, which occurs not too far from the image 3 that was actually intended to be touched, can be correctly interpreted and evaluated by the control unit 2. However, if the striking point of the finger under the influence of a severe sideways acceleration deviates sideways so far that the image 3 of an adjacent key is hit, an input error is nevertheless the consequence. For this reason, the control unit 2 under the influence of a greatly changing acceleration not only shifts an edge of the sensitive regions 7 assigned to the keys but the entire sensitive regions. This can result in that, as shown in FIG. 4, for example a sensitive region 7-2, which when touched is interpreted as selecting the number “2”, only incompletely overlaps the image 3-2 of the key “2” and instead the sensitive region 7-1 of the key “1” reaches as far as into the image 3-2 of the key “2”.

When the acceleration to the left diminishes again when leaving the curve, in another embodiment, the control unit 2 reacts accordingly in that it shifts, for a time, the detection regions 7 assigned to the keys to the left. Analogously, travelling through a right-hand curve initially leads to a shifting of the detection regions 7 to the left for a time and subsequently, on leaving the curve, to the right.

Analogously, changes of the accelerations in z-direction lead to a z-shift of the detection regions 7 relative to the images 3 of the associated keys, as shown in FIG. 5. Since accelerations in y and z-directions can occur simultaneously, the control unit is able to deflect the detection regions simultaneously in y and z-directions.

The reliability and comfort with which the input device can be operated depends on the accuracy with which the shift of the detection region 7 reproduces the deflection of the hand of a user under changing accelerations. In an embodiment, the relationship between deflection and change of the acceleration is empirically determined beforehand, and a proportionality factor with which the control unit 2 multiplies the measured acceleration change in y or z-direction in order to obtain the shift of the part regions 7, or a function, which describes the relationship between acceleration change and deflection is permanently stored in the control unit 2.

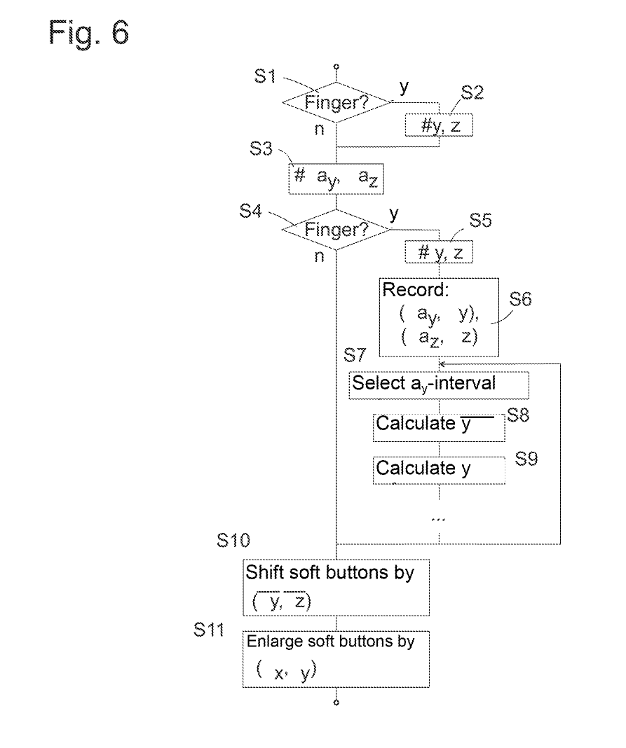

However, it is also conceivable that such a relationship between acceleration change and deflection varies depending on vehicle type and/or user. In order to take this into account, the control unit 2 is equipped, according to a further embodiment, to determine itself the relationship between acceleration change and deflection, using it as a base for the shift of the sensitive regions 7. A working method of such a self-learning control unit 2, in accordance with an exemplary embodiment, is shown in the flow diagram of FIG. 6. In step S1 it is determined if a finger of the user is present on the display screen 1. If yes, the coordinates (y, z) of the point touched by the finger are determined in step S2.

In step S3, the change of the accelerations in y and z-direction is determined When the shown method is repeated at regular time intervals of up to a few 100 ms, the determined acceleration change ay, az can be the difference between acceleration values measured in consecutive iterations of the method.

When, following this, in step S4 the finger is still present on the display screen 1, its coordinates are detected anew in step S5, and value pairs consisting of the acceleration change ay, az in y aforesaid direction and the change of the y and z coordinates between two consecutive measurements S5, S2 resulting from this are recorded in step S6. During the course of the method, a statistic of accelerations and finger movements Δy, Δz in y and z-direction resulting from this is obtained in this way. When this statistic is extensive enough in order to make possible reliable statements it is evaluated. To this end, the band width of the measured acceleration changes ay az is divided into a plurality of intervals. In step S7, one of these intervals is selected and, for all measured value pairs whose acceleration value ay falls into this interval, a mean value of the finger movement Ay is calculated in step S8. In addition, in step S9, a standard deviation ζy of the y-movement can be calculated. The step S7, S8 and possibly S9 are repeated for all repeated intervals of the y-acceleration and following this the same evaluation for the z-acceleration and finger movements resulting from this carried out. Thus, upon a following iteration of the method, the probable deviation (Δy, Δz) between the point on the display screen 1 between the point aimed at by the user and actually hit can be calculated for each acceleration change measured in step S3 and the sensitive regions 7 are shifted according to the calculated deviation in step S10 so that they are exactly located where the finger of the user in fact predictably touches the display screen 1.

If a calculation of the standard deviation (S9) has taken place, an enlargement of the sensitive regions 7, as shown in FIG. 3, can additionally take place in step S11, wherein the extent of the enlargement is dimensioned based on the calculated standard deviation. The sensitive regions 7 are thus the greater, the more the accuracy of the user is reduced. An upper limit of the enlargement is provided by the requirement that the sensitive regions 7 of different keys do not overlap.

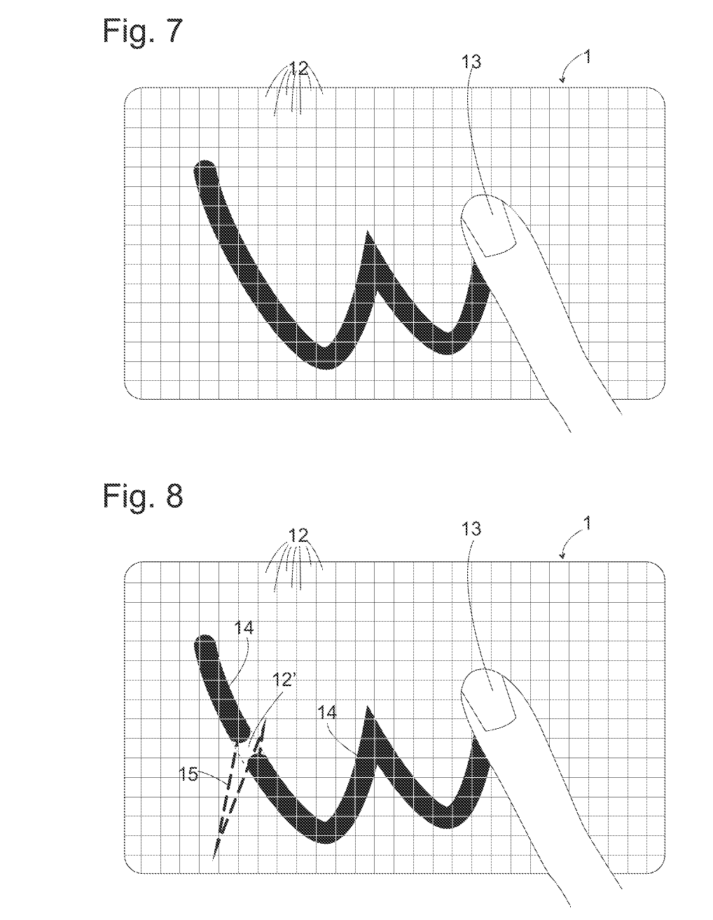

FIG. 7 shows the display screen with an alternative non key-based input method. Here, the sensor surface of the display screen 1 is divided, matrix-like into a multiplicity of fields 12, the limits of which—other than in the Figure—are not visible on the display screen 1, but each of which otherwise has the function of a key insofar as touching one of the fields 12 by a finger 13 of a user prompts the control unit 2 to supply a detection signal, which uniquely specifies the touched field 12, i.e. by means of coordinates in y and z-direction. When the user with his finger 13 writes a letter, in this case the letter W on the display screen 1, the control unit 2 supplies a sequence of detection signals, which designated the fields 12 consecutively touched by the finger 13 and by means of which a device to be controlled through the input, for example a navigation device, detects the letter written by the user by means of OCR-algorithms known per se.

When, while the letter is being written, the vehicle is subjected to an abrupt acceleration, the finger 13 of the user deviates from the intended path and describes a curve on the display screen 1 as shown in FIG. 8. Bold continuous arcs 14 of the curve correspond to the actually intended movement of the finger 13, a thinner interrupted zigzag line 15 is caused through the vibration.

In that the control unit 2, as described with reference to FIG. 6, shifts the entirety of the fields 12 on the display screen 1 in the direction of the active acceleration change, it can be achieved that in the time, in which the finger moves along the zigzag line 15, exactly that field 12′ (or those fields) co-move under the fingertip, which in the un-accelerated state lie(s) between the ends 14. The consequence of the detection signals, which the control unit 2 supplies under the influence of the vibration, therefore does not differ from that obtained with undisturbed input. The zigzag line 15 thus remains without influence on the detection result, and the letter written by the user is correctly recognised.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. An input device comprising:
a sensor surface that is sensitive to a touch by a foreign body; and
a control unit that is configured to determine a first sensitive region of the sensor surface and, when the first sensitive region is touched by the foreign body, to supply a predetermined first detection signal, wherein the control unit comprises means for estimating a direction of an acceleration change acting parallel to the sensor surface and is configured, under an effect of the acceleration change, to shift the first sensitive region at times in an active direction of the acceleration change.

2. The input device according to claim 1, wherein an extent of a shift of the first sensitive region increases with an amount of the acceleration change.

3. The input device according to claim 2, wherein dimensions of the first sensitive region are greater, the stronger the acceleration change.

4. The input device according to claim 3, wherein the dimensions of the first sensitive region in the active direction of the acceleration change are greater, the stronger the acceleration change.

5. The input device according to claim 4, wherein the dimension of the first sensitive region perpendicularly to the active direction of the acceleration change is independent of the amount of the acceleration change.

6. The input device according to claim 1, wherein the sensor surface is simultaneously configured as a dynamically activatable display surface on which a symbol showing a position of the first sensitive region is represented.

7. The input device according to claim 6, wherein a position of the symbol is independent of the acceleration change.

8. The input device according to claim 1, wherein the control unit is configured to determine a second sensitive region and when the second sensitive region is touched, to supply a predetermined second detection signal, and wherein the first sensitive region under the effect of the acceleration change is shifted so far that it overlaps, at least at times, with the second sensitive region in an un-accelerated state.

9. The input device according to claim 1, wherein the control unit further comprises a means for estimating an acceleration of the sensor surface and wherein the means for estimating the acceleration comprise a speedometer and a steering angle sensor.

10. The input device according to claim 1, wherein the sensor surface and an acceleration sensor are connected in a unit.

11. The input device according to claim 1, wherein the control unit is configured to estimate a movement of the foreign body resulting from an active acceleration change by means of previously measured movements and to determine an extent of the shift of the first sensitive region by means of an estimated movement.

12. The input device according to claim 1, wherein the input device is installed in a motor vehicle.
